(19) United States
(12) Patent Application Publication
(10) Pub. No.: US 2014/0337950 A1
(43) Pub. Date: Nov. 13, 2014

(54) Method and Apparatus for Secure Communications in a Wireless Network

(71) Applicant: Futurewei Technologies, Inc., Plano, TX (US)

(72) Inventors: Yunsong YANG, San Diego, CA (US); Younghoon KWON, San Diego, CA (US); Zhigang RONG, San Diego, CA (US)

(73) Assignee: Futurewei Technologies, Inc., Plano, TX (US)

(21) Appl. No.: 14/271,181

(22) Filed: May 6, 2014

Related U.S. Application Data
(60) Provisional application No. 61/820,228, filed on May 7, 2013.

(51) Int. Cl. H04W 12/08

(52) U.S. Cl. CPC H04W 12/08
USPC 726/7

(57) ABSTRACT

A method and apparatus for secure communications between an access point and a station in a wireless network is provided. The station receives a first message from the access point in the wireless network, the first message includes a first hashed service set identifier (SSID) generated by the access point by performing a first hash function on an SSID associated with the access point. The station generates a second hashed SSID by performing the first hash function on an SSID known by the station, determines whether the second hashed SSID matches the first hashed SSID. When the second hashed SSID matches the first hashed SSID, the station sends a second message to the access point.

### CROSS-REFERENCE TO RELATED APPLICATIONS

This application claims the benefit of U.S. Provisional Application No. 61/820,228, filed on May 7, 2013, entitled “Method and System for Indicating a Service Set Identifier”, which is hereby incorporated by reference in its entirety.

### TECHNICAL FIELD

The present disclosure relates to communications, and in particular, to a method and apparatus for secure communications in a wireless network.

### BACKGROUND

A wireless LAN (WLAN) or Wi-Fi (wireless fidelity) communication system may include an access point (AP) and one or more stations (STAs), which the AP serves. An AP may also be referred as a communications controller, base station, access node, etc. A STA may be referred to as a client device, device, terminal, mobile station, user equipment, etc. Today, typical examples of WLAN STAs include laptops, smartphones, tablets, sensors, etc.

FIG. 1 illustrates a protocol diagram of a conventional communications sequence for a STA connecting with a WLAN AP. In Steps 100-104, the STA discovers the WLAN AP either via passive scanning (e.g., by receiving a Beacon frame) or via active scanning (e.g., by sending a Probe Request frame and then receiving a Probe Response frame) based on the IEEE 802.11 standard. It is noted that Steps 102 and 104 can be either an alternative to or an optional supplement of Step 100. In Steps 106-112, the 802.11 open system authentication and association procedures are used to exchange robust security network (RSN) parameters between the STA and AP. In Step 114, an EAP/802.1X/Radius Authentication is performed to supplement the open system authentication with mutual authentication between the STA and an Authentication Server. In Step 116, a 4-way handshake is performed so that the STA can mutually trust the AP and share their keys with the indication of the pair-wise master key (PMK). In Step 118, the secured data communications may begin.

The AP is configured with a service set identifier (SSID) for WLAN discovery. The AP may broadcast its SSID in Beacon frames to announce its presence. The STA may display the received SSID to show the available WLAN list to the end user. As a result, for example, the user may choose to add an AP to a preferred WLAN list. Afterwards, the STA may search for the preferred AP(s) using the corresponding SSID(s) automatically. Besides Beacon frames, an SSID may be presented in other management frames such as Probe Requests, Probe Responses, Association Requests, and Reassociation Requests.

The SSID is traditionally transmitted over the air using plain text, and consequently has been viewed as an open invitation to hackers or attackers. One existing solution is to “hide” the SSID by giving out a null SSID in the Beacon or refusing to answer a Probe Request if the SSID in the Probe Request does not specifically match the SSID of the AP. However, this manner of hiding the SSID may be ineffective as there are other ways to obtain the SSID in plain text, e.g., by passively monitoring the air for a legitimate client device that is trying to actively scan or associate with the AP, or by actively sending a faked Deauthentication frame to an already connected legitimate client device and then monitoring its Reassociation Request.

Additionally, there is an issue of user privacy, as the SSIDs of a STA's preferred WLANs, which may be sent in the Probe Request, Association Request, or Reassociation Request frames together with the media access control (MAC) address of the STA (which is sent in a transmitter address (TA) field in these frames), can be used for tracking user locations, inferring a user's personal lifestyle (e.g., by the entertainment places visited) or health conditions (e.g., by the medical doctor's office visited), or a social relationship between users (e.g., by a shared WLAN of a business office or school), etc.

Conventional solutions addressing these security and privacy issues usually involve the establishment of a shared encryption key between the AP and the STA before transmitting the encrypted SSID over the air. This requires a significant change to the existing standardized procedure and incurs additional delay due to the steps required to establish the shared encryption key first. Accordingly, mechanisms for addressing these security and privacy issues are desired.

### SUMMARY

Example embodiments of the present disclosure provide a method and apparatus for secure communications in a wireless network.

In accordance with an embodiment of the present disclosure, a method for secure communications between an access point and a station in a wireless network is provided. The method is performed by the station, and includes: receiving a first message from the access point in the wireless network, the first message includes a first hashed service set identifier (SSID) generated by the access point by performing a first hash function on an SSID associated with the access point; generating a second hashed SSID by performing the first hash function on an SSID known by the station; determining whether the second hashed SSID matches the first hashed SSID; and sending a second message to the access point when the second hashed SSID matches the first hashed SSID.

In accordance with another embodiment of the present disclosure, a station in a wireless network is provided. The station includes a receiver, a processor and a transmitter. The receiver is configured to receive a first message from an access point in the wireless network. The first message includes a first hashed service set identifier (SSID) generated by the access point by performing a first hash function on an SSID associated with the access point. The processor is coupled to the receiver and configured to: generate a second hashed SSID by performing the first hash function on an SSID known by the station; and determine whether the second hashed SSID matches the first hashed SSID. The transmitter is coupled to the processor and configured to send a second message to the access point when the second hashed SSID matches the first hashed SSID.

In accordance with yet another embodiment of the present disclosure, a method for secure communications between an access point and a station in a wireless network is provided. The method is performed by the access point and includes: receiving a first message from the station in the wireless network, the first message includes a first hashed service set identifier (SSID) generated by the station by performing a first hash function on an SSID known by the station; generating a second hashed SSID by performing the first hash function on an SSID associated with the access point; determining whether the second hashed SSID matches the first hashed SSID; and sending a second message to the station when the second hashed SSID matches the first hashed SSID.

In accordance with a further embodiment of the present disclosure, an access point in a wireless network is provided. The access point includes a receiver, a processor and a transmitter. The receiver is configured to receive a first message from a station in the wireless network. The first message includes a first hashed service set identifier (SSID) generated by the station by performing a first hash function on an SSID known by the station. The processor is coupled to the receiver and configured to: generate a second hashed SSID by performing the first hash function on an SSID associated with the access point; and determine whether the second hashed SSID matches the first hashed SSID. The transmitter is coupled to the processor and configured to send a second message to the station when the second hashed SSID matches the first hashed SSID.

Aspects of this disclosure may provide the following benefits: (1) protecting SSID privacy; (2) protecting user privacy (such as location or interests); (3) making it more costly for an attacker to impersonate a legitimate AP or STA; and (4) maintaining backward compatibility such that legacy STAs or legacy APs do not misbehave when a Hashed SSID is used. Aspects of this disclosure may be effectuated without significantly departing from existing telecom standards.

### BRIEF DESCRIPTION OF THE DRAWINGS

For a more complete understanding of the present disclosure, reference is now made to the following description taken in conjunction with the accompanying drawings, in which:

FIG. 1 illustrates a protocol diagram of a communications sequence in a conventional wireless network;

FIG. 2 is a schematic diagram of a Wireless Local Area Network (WLAN) system according to embodiments of the present disclosure;

FIG. 3 illustrates a diagram of an exemplary method for modifying service set identifiers (SSIDs) according to embodiments of the present disclosure;

FIG. 4 illustrates a diagram of another exemplary method for modifying SSIDs according to embodiments of the present disclosure;

FIG. 5 illustrates a diagram of an exemplary format for a Hashed SSID information element (IE) according to embodiments of the present disclosure;

FIG. 6 illustrates a diagram of another exemplary format for a Hashed SSID IE according to embodiments of the present disclosure;

FIG. 7 illustrates a protocol diagram of a communications sequence according to an embodiment of the present disclosure;

FIG. 8 illustrates a protocol diagram of a communications sequence according to another embodiment of the present disclosure; and

FIG. 9 illustrates a block diagram of a processing system that may be used to implement the devices and methods described herein.

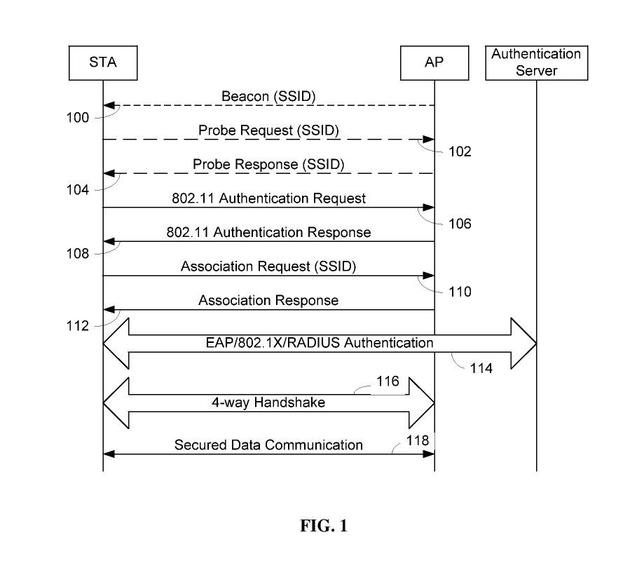

### DETAILED DESCRIPTION OF ILLUSTRATIVE EMBODIMENTS

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

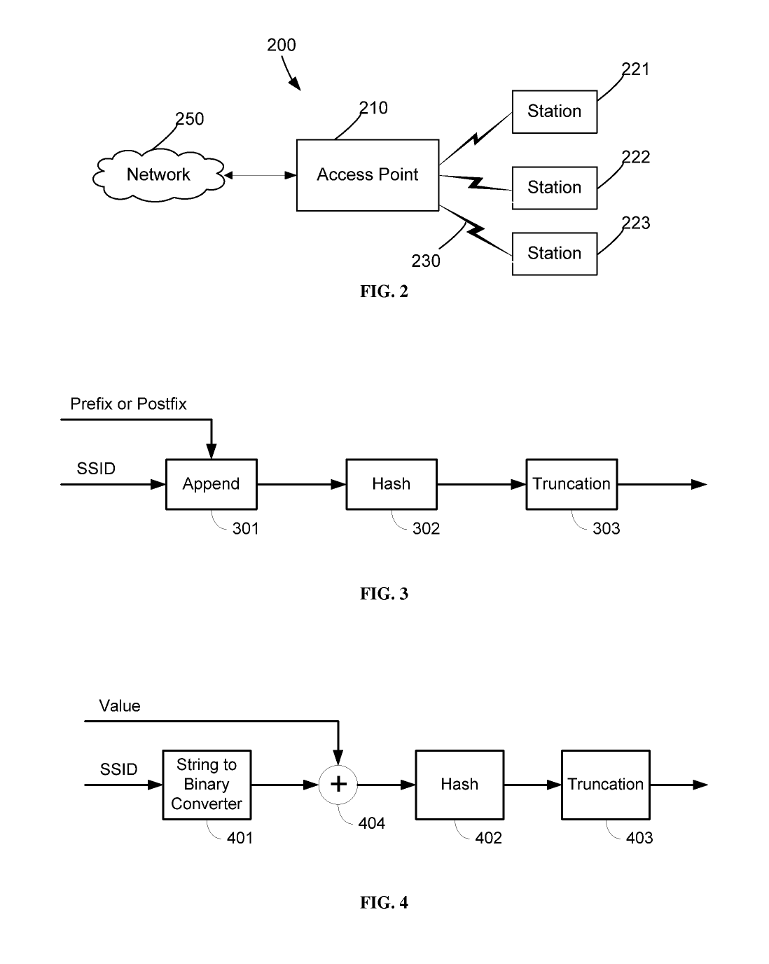

FIG. 2 is a schematic diagram of a Wireless Local Area Network (WLAN) system 200 according to an embodiment of the present disclosure. The WLAN system 200 includes a central station (e.g., Access Point (AP) 210) connected to a plurality of stations (STAs), for example, STA 221, STA 222 and STA 223. Although FIG. 2 depicts three STAs, the WLAN system 200 can include different numbers of STAs in various scenarios and embodiments. The AP 210 and the STAs 221, 222 and 223 communicate via a WLAN 230 which can be, e.g., an 802.11-based network (such as 802.11, 802.11b, 802.11a/b, 802.11g, and 802.11n). The AP 210 communicates with any number of external devices (not shown) via a network 250. In different scenarios, the network 250 may be an Internet, an intranet, or any other wired, wireless, or optical network. The AP 210 can be configured to provide wireless communications to the STAs 221, 222 and 223. Depending on the particular configuration, the STAs 221, 222 and 223 may be a personal computer (PC), a laptop computer, a mobile phone, a personal digital assistant (PDA), or other device configured for wirelessly sending or receiving data. Furthermore, the AP 210 may be configured to provide a variety of wireless communications services, such as: Wireless Fidelity (Wi-Fi) services, Worldwide Interoperability for Microwave Access (WiMAX) services, and wireless session initiation protocol (SIP) services. In addition, although all the STAs 221, 222 and 223 communicate with the AP 210 in this embodiment, as will be apparent to those skilled in the art direct peer-to-peer communications between two STAs may also be accommodated with modifications to the WLAN system 200.

This disclosure provides techniques for increasing service set identifier (SSID) security and user privacy (e.g., location and interests), making it more costly for an attacker to impersonate a legitimate AP or STA, and maintaining backward compatibility such that legacy STAs or legacy APs do not misbehave when the identifier, instead of the plain text SSID is used.

Aspects of this disclosure address the above mentioned security and privacy concerns by using an identifier that is generated from a SSID (e.g., plain text SSID) so that the SSID is not transmitted over a wireless fidelity (Wi-Fi) air interface in plain text form. The SSID can be pre-installed on a legitimate STA by secured means, e.g., by manually typing it in via a setup menu on the STA, using a Wi-Fi Protected Setup (WPS) procedure, or using a secured out-of-band communications channel such as a cellular connection or a near field communication (NFC) link as a part of an authorization transaction. The identifier can be used by the STA to recognize or to indicate its preferred WLAN, while a hacker or an unauthorized third party is not able to derive the SSID from the received identifier.

In some embodiments, the SSID may be communicated between the STA and the AP using a cryptographically hashed SSID instead of a plain text SSID. For instance, the cryptographically hashed SSID may be generated by using a SHA-256 hash function. The hash output of the hash function may be further truncated to a fixed, shorter length. Before being hashed, the SSID may be modified by a string or value, e.g., by a TimeStamp. For instance, the TimeStamp is provided in a Beacon frame and Probe Response frame and can be used to modify the SSID before the SSID is hashed by the hash function. Thus, a hacker will not receive the same hashed SSID twice, as it takes more than 580,000 years for the 64-bit TimeStamp field to repeat itself. The SSID may also be modified by a type of a frame that carries the hashed SSID. The SSID may also be modified by a random number (e.g., a nonce) or sequence number generated by the STA or AP, or by an identifier (e.g., MAC address) of the STA or AP. Aspects of this disclosure are related to the disclosure in U.S. patent application Ser. No. 14/105,895, filed on Dec. 13, 2013 and entitled “Systems and Methods for Pre-Association Discovery”, which is incorporated by reference herein in its entirety.

FIG. 3 illustrates functional blocks for an exemplary method of generating a hashed SSID. Before performing a hash function on an SSID, the SSID is modified with an item to obtain a modified SSID as an input of the hash function. The Prefix or Postfix in FIG. 3, which is used to modify the SSID, may include a string expression of a frame type of a frame that carries the hashed SSID, Timestamp, nonce, MAC address, sequence number, or a combination thereof. The Prefix or Postfix is attached to another string (e.g., the SSID) as a prefix or postfix to the SSID. The block Append 301 modifies the SSID, for example, by performing a function of appending the Prefix or Postfix to a string of the SSID to obtain the modified SSID. The block Hash 302 performs a hashing operation on a given input (e.g., the modified SSID) based on a cryptographic hash function, such as a SHA-256 hash function. The block Truncation 303 performs a truncation function on an output of the block Hash 302 (e.g., output of the hash function) to obtain a hashed SSID with a shorter and fixed length so as to lower the overhead and simplify the design of an information element (IE) that is used to carry the hashed SSID.

FIG. 4 illustrates functional blocks for another exemplary method of generating a hashed SSID. The Value depicted in FIG. 4 may include a value corresponding to a frame type of a frame that carries the hashed SSID, Timestamp, nonce, MAC address, sequence number, or a sum thereof, and is to be added to another number by an Adder 404. The block String to Binary Converter 401 converts the text string of an SSID to a binary number. It should be noted that binary numbers and a String to Binary Converter are merely used herein as an example and using other numeral systems with different bases are also possible. The Adder 404 produces the sum of two numbers. The block Hash 402 performs a hashing operation on a given input (e.g., output of the Adder 404) based on a cryptographic hash function, such as a SHA-256 hash function. The block Truncation 403 performs a function of truncating the hash output to a shorter, fixed length so as to lower overhead and simplify design of an information element (IE) that carries the hashed SSID.

Aspects of this disclosure also provide techniques for creating a new Hashed SSID IE to carry the hashed SSID in a Beacon frame, Probe Request frame, Probe Response frame, Association Request frame, or Reassociation Request frame.

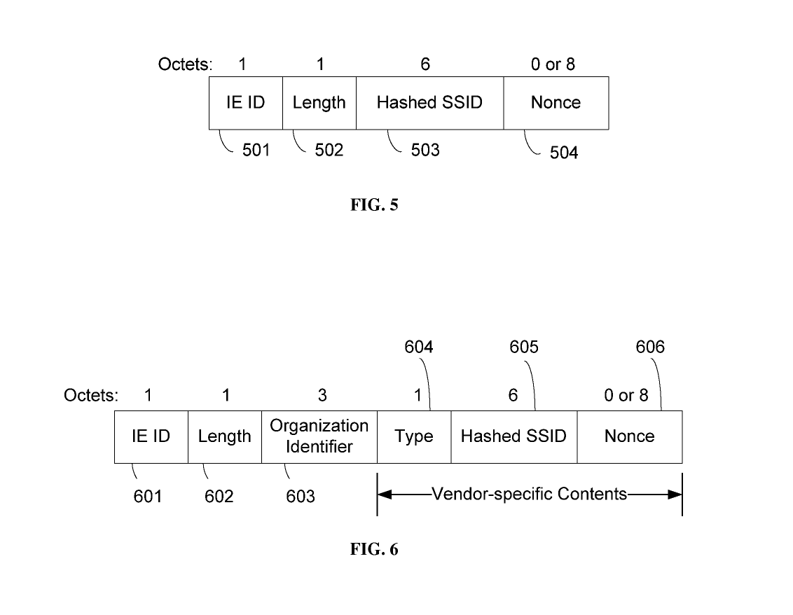

FIG. 5 illustrates an exemplary format for a Hashed SSID IE that is used to carry the hashed SSID. The Hashed SSID IE includes an IE ID field 501 carrying a new IE identifier defined for Hashed SSID IE, a Length field 502 indicating the number of total octets after the Length field 502 in the Hashed SSID IE, and a Hashed SSID field 503 carrying the hashed SSID. A Nonce field 504 indicating a random number, which is generated and used for modifying the SSID by an AP or STA that transmits the Hashed SSID IE, may be optionally presented in the Hashed SSID IE. The presence or absence of the Nonce field 504 in the Hashed SSID IE may be inferred from the value of the Length field 502.

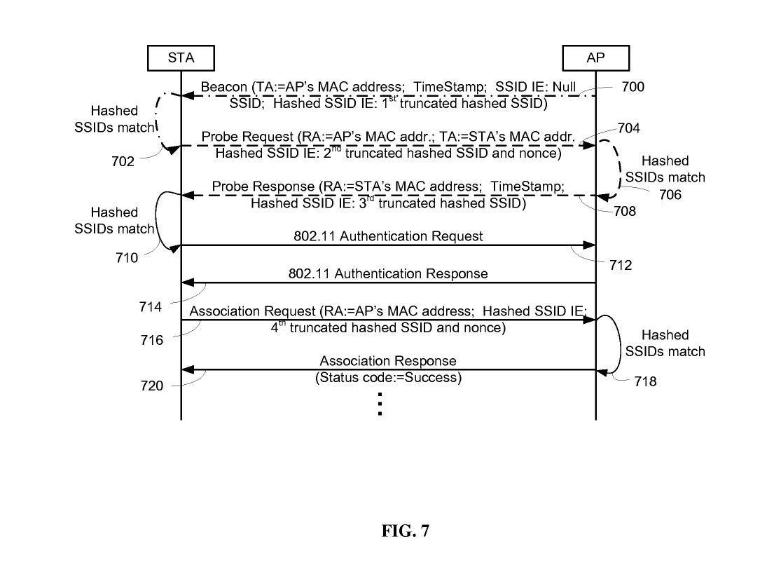

FIG. 6 illustrates another exemplary format for a Hashed SSID IE, as may be used in the Wi-Fi Alliance (WFA) certification specification using the Institute of Electrical and Electronics Engineers (IEEE) 802.11 defined vendor-specific IE format. Aspects of this disclosure may be related to IEEE Standard 802.11-2012, which is incorporated herein by reference as if reproduced in its entirety. As shown in FIG. 6, the Hashed SSID IE includes an IE ID field 601, Length field 602, Organization Identifier field 603, Type field 604 and Hashed SSID field 605. The IE ID field 601 is set to a value of, for example, “221” for the 802.11 defined vendor-specific IE format. The Length field 602 specifies the number of total octets after the Length field 602 in the Hashed SSID IE. The Organization Identifier field 603 is set to a value of, for example, “50 6F 9A” for WFA. The Type field 604 carries a new identifier allocated by the WFA for the Hashed SSID IE. The Hashed SSID field 605 is used to carry the hashed SSID (e.g., the first six octets of the hashed SSID). Optionally, the Hashed SSID IE includes a Nonce field 606 that indicates a random number that is generated and used for modifying the SSID by an AP or STA that transmits the Hashed SSID IE. The presence or absence of the Nonce field 606 in the Hashed SSID IE may be inferred from the value of the Length field 602. It should be noted that WFA is used herein merely as an example. Other organizations or manufacturers may use the IEEE 802.11 defined vendor-specific IE format with similar IE contents as described herein, except the Organization Identifier field should be set to represent the appropriate organization, to implement the same concept.

In some embodiments, the presence of the Hashed SSID IE in a Beacon frame or Probe Response frame indicates that the AP is capable of using a hashed SSID. In the same or other embodiments, the presence of the Hashed SSID IE in a Probe Request frame, Association Request frame, or Reassociation Request frame indicates that the STA is capable of using a hashed SSID.

FIG. 7 illustrates a message exchange diagram showing a message exchange between a STA and a WLAN AP according to an embodiment of the present disclosure. The steps are described as follows:

At Step 700, the AP, which is capable of hashed SSID, may broadcast a Beacon frame periodically. The Beacon frame includes a transmitter address (TA) field, a TimeStamp field, an SSID IE and a Hashed SSID IE. The TA field is set to the MAC address of the AP. The SSID IE is set to a null SSID, and the Hashed SSID IE includes a first hashed SSID generated from the SSID associated with the AP. The details of generating the first hashed SSID are disclosed, e.g., in FIGS. 3-4 and in the aforementioned U.S. patent application Ser. No. 14/105,895. The TimeStamp field includes a TimeStamp, which changes constantly and repeats only after a very long time (e.g., 580,000 years). When the TimeStamp is used for generating the first hashed SSID, the TimeStamp helps the AP to avoid sending a static hashed SSID so as to make it more costly for an attacker trying to impersonate as the legitimate AP. Since the SSID IE is set to a null SSID, a legacy STA sees the Beacon frame as a Beacon frame with hidden SSID enabled. The legacy STA may check if the MAC address of the AP belongs to one of the APs in the preferred WLAN List of the legacy STA. If the MAC address of the AP is not one of the APs in the preferred WLAN List, the legacy STA may ignore the AP.

At Step 702, a STA, capable of hashed SSID, uses the SSID(s) of its preferred AP(s) to generate the corresponding hashed SSID(s) (first hashed SSID of the STA). The STA may use the same method and parameters that the AP uses to generate the first hashed SSID, which is carried in the Beacon frame. For example, the STA uses the same method to modify the SSID(s) known by the STA (e.g., the STA uses the same TimeStamp value in the Beacon frame to modify the SSID(s) known by the STA), uses the same hash function on the modified SSID(s) and the same truncation function to truncate the output of the hash function to obtain one or more hashed SSIDs. The hashed SSID(s) in Step 702 may be generated according to FIGS. 3-4 and the aforementioned U.S. patent application Ser. No. 14/105,895. The STA compares the one or more hashed SSIDs with the received first Hashed SSID to determine if there is a match. Steps 700 and 702 may be considered to be part of a passive scanning procedure in which the STA can obtain information about the AP so that the STA can decide whether to connect with the AP or not.

Generally, the STA may use either active scanning or passive scanning, although in some cases both active scanning and passive scanning may be used. For example, if the STA obtains sufficient information from the Beacon frame and decides to make a connection with the AP, the STA can initiate an authentication procedure (i.e., skipping to Step 712) without sending a Probe Request frame to the AP and receiving a Probe Response frame from the AP. That is, the STA may use passive scanning without using active scanning. In this case, the AP does not perform Step 706. However, if the STA does not have sufficient information from the Beacon frame, then the STA may utilize active scanning to obtain additional information from the AP in order to make a connection with the AP. In such a situation, the STA may perform both passive scanning and active scanning.

At Step 704, when there is a match, the STA initiates active scanning by sending a Probe Request frame to the AP. The Probe Request frame may include a receiver address (RA) field set to the AP's MAC address, a TA field set to the STA's own MAC address, a Hashed SSID IE including a second hashed SSID of the STA generated from the SSID for which the match is found, without sending the SSID explicitly. The STA may use the method shown in FIGS. 3-4 and the aforementioned U.S. patent application Ser. No. 14/105,895 to generate the second hashed SSID of the STA. The STA may generate an item and use the item to modify the SSID for which the match is found to obtain a modified SSID. The item may include, for example, a random number (i.e., a nonce). Using the random number to generate the second hashed SSID makes it more costly for an attacker trying to impersonate a legitimate STA. The STA performs a hash function on the modified SSID and performs a truncation function on an output of the hash function to obtain the second hashed SSID. In some embodiments, the hash functions in Steps 700 and 704 may include a same cryptographic hash function. In some embodiments, the truncation functions in Steps 702 and 704 may be the same. The STA may send the random number to the AP by including the random number in the Hashed SSID IE. The AP may memorize the nonce values that have been recently used by each legitimate STA and refuse to answer a Probe Request frame that uses a same nonce value that has been recently used by the same STA (i.e., the same MAC address in the TA field in the Probe Request frame), if the MAC address, in addition to the nonce, is also used for generating the hashed SSID. Also, the AP may memorize the nonce values that have been recently used by any STA, if the nonce alone is used for generating the Hashed SSID. This will force the hackers to collect a much longer history of the Probe Request frame sent by legitimate STAs, to beyond the capacity of the AP's memory, thus making it more costly for the hackers.

At Step 706, the AP generates its second hashed SSID, by using the same method and parameters that the STA uses to generate the hashed SSID in Step 704. In one embodiment, the AP uses the same nonce number in the received Probe Request frame to modify the SSID associated with the AP, performs the same hash function on the modified SSID and truncates the output of the hash function with the same truncation function to generate the second hashed SSID of the AP. Then the AP compares the second hashed SSID of the AP with the second Hashed SSID received from the STA to determine if there is a match.

At Step 708, when there is a match, the AP sends back a Probe Response frame with a third hashed SSID of the AP generated from the SSID associated with the ΔP, without sending the SSID explicitly. The AP may generate the third hashed SSID according to the method shown in FIGS. 3-4 and the aforementioned U.S. patent application Ser. No. 14/105,895. Similar to Step 700, the AP may use the TimeStamp value in the Probe Response frame to generate the third Hashed ID, for the same reason depicted in Step 700.

At Step 710, the STA further checks if a third hashed SSID of the STA matches the third hashed SSID of the AP. The STA generates its third Hashed SSID from, for example, the SSID that the STA used to generate the hashed SSID in Step 704, by using the same method and parameters that the AP uses to generate its third hashed SSID in Step 708 (e.g., the same TimeStamp value in the received Probe Response frame, the same frame type of “Probe Response”). The aforementioned U.S. patent application Ser. No. 14/105,895, describes why and how using difference truncated hash of the same ID in subsequent frames (with different frame types) and checking iteratively if the match persists can help to reduce the residual false match probability. If the third hashed SSID of the STA matches the third hashed SSID of the AP, the STA sends an Authentication Request frame to the AP at Step 712 and receives an Authentication Response frame from the AP at Step 714. Steps 712 and 714 are the same as the current 802.11 Open System Authentication procedure. However, at any subsequent step, if the third hashed SSID of the STA does not match the third hashed SSID of the AP, the discovery or association procedure may be stopped.

At Step 716, the STA sends an Association Request frame to the AP with a fourth hashed SSID of the STA, without sending the SSID in plain text form. Similar to Step 704, the STA may also include a random number (i.e., a nonce) in the Hashed SSID IE of the Association Request frame and use the random number to generate the fourth hashed SSID so that an attacker cannot rely on a static hashed SSID to impersonate a legitimate STA, thus making it more costly for the attacker.

At Step 718, the AP generates its fourth hashed SSID, by using the same method and parameters that the STA used to generate the hashed SSID in Step 716. In one embodiment, the AP uses the same nonce number in the received Association Request frame to modify the SSID associated with the AP, performs the same hash function on the modified SSID and truncates the output of the hash function with the same truncation function, to generate the fourth hashed SSID of the AP. Then the AP further checks if its fourth hashed SSID matches the hashed SSID included in the received Association Request frame.

At Step 720, when there is a match, the AP sends back an Association Response frame with a Status code of “Success”.

It is noted that after the STA receives the Association Response frame in Step 720, an EAP/802.1X/Radius Authentication may be performed to supplement the open system authentication with mutual authentication between the STA and an Authentication Server. Then, a 4-way handshake may be performed so that the STA can mutually trust the AP and share their keys with the indication of the pair-wise master key (PMK). Afterwards, the secured data communications may begin.

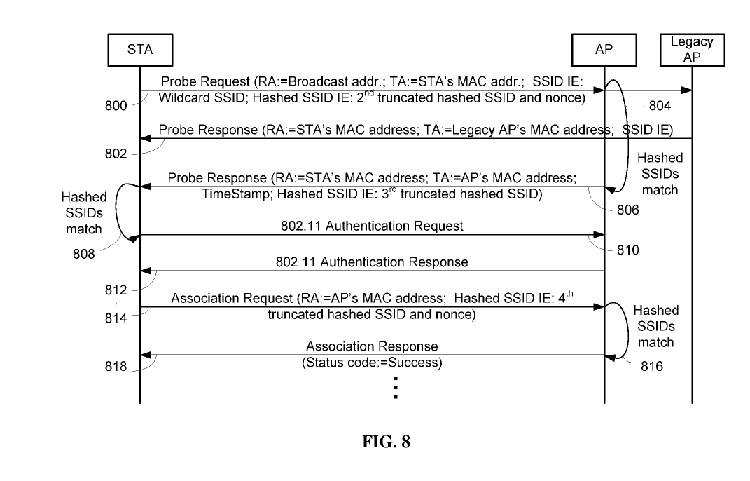

FIG. 8 illustrates a message exchange diagram showing a message exchange between a STA and a WLAN AP according to another embodiment of the present disclosure. The steps are described as follows:

At Step 800, a STA, which is capable of hashed SSID, knows the desired SSID of an AP capable of hashed SSID, but does not know the MAC address of the AP (as may be a typical scenario when using a WLAN in an airport lounge). Thus, the STA broadcasts a Probe Request frame that appears as a Wildcard Probe Request to legacy APs, but appears as a dedicated Probe Request frame for all APs capable of hashed SSID (due to the requirement of matching the hashed SSID). That is, an AP capable of hashed SSID does not send a response unless the hashed SSIDs generated by the respective AP and STA match. The Probe Request frame includes an SSID IE that is set to wildcard SSID and a Hashed SSID IE that includes a hashed SSID generated from an SSID known by the STA. The STA may use the method shown in FIGS. 3-4 and the aforementioned U.S. patent application Ser. No. 14/105,895, to generate the hashed SSID. For example, the STA generates an item and uses the item to modify the SSID to obtain a modified SSID. The item may include, for example, a random number (i.e., a nonce). Using the random number to generate the second hashed SSID makes it more costly for an attacker trying to impersonate a legitimate STA. The STA performs a hash function on the modified SSID and performs a truncation function on an output of the hash function to obtain the hashed SSID. The Hashed SSID IE may also include the nonce so that the AP can use the nonce to modify the SSID associated with the AP when the AP generates a hashed SSID.

At Step 802, a legacy AP nearby treats the Probe Request frame as a Wildcard Probe Request and sends a Probe Response frame. If the STA is not interested in it, the message exchange between the STA and the legacy AP ends.

At Step 804, the AP capable of hashed SSID generates a hashed SSID by using the same method and parameters that the STA used to generate the hashed SSID in Step 800. For example, the AP uses the same nonce number in the received Probe Request frame to modify the SSID associated with the AP, performs the same hash function on the modified SSID and truncates the output of the hash function with the same truncation function to generate the hashed SSID of the AP. Then the AP determines if the hashed SSID generated by the AP matches the received hashed SSID.

At Step 806, when the hashed SSID generated by the AP matches the received hashed SSID, the AP thus sends back a Probe Response frame, which includes the MAC address of the AP in the TA field. After this step, the frames exchanged between the AP and the STA use the unicast MAC address in the RA field. The remaining steps may be similar to those described in the previous example shown in FIG. 7. For example, Steps 808-818 may be similar to Steps 710-720 of FIG. 7.

Aspects of this disclosure also provide techniques for maintaining backward compatibility. One exemplary technique is described as follows: When an AP, capable of a hashed SSID, transmits a Beacon frame with the Hashed SSID IE, such as Step 700 in FIG. 7, the AP may include an SSID IE set to the null SSID. A legacy STA sees the AP as an AP with hidden SSID enabled. Then the legacy STA may check the MAC address of the AP to see if the AP belongs to one of the preferred APs of the legacy STA. If not, the legacy STA will ignore this AP. It does not make a sense to send both hashed SSID and the plain text SSID simultaneously. The reason to include a null SSID in the legacy SSID IE here is to avoid otherwise possible erroneous behavior of an implementation of a legacy STA if the legacy STA sees a Beacon frame without an SSID IE. When a STA, capable of hashed SSID, transmits an Association Request frame or Reassociation Request frame with the Hashed SSID IE, such as Step 716 in FIG. 7, the STA may remove the legacy SSID IE entirely from the Association Request frame or Reassociation Request frame as the STA already has the AP's MAC address thus may set the RA field in the Request frame to the AP's MAC address. A legacy AP will ignore the Association Request frame or the Reassociation Request frame since the RA field does not match for it.

Another exemplary technique is described as follows: When a STA, capable of hashed SSID, transmits a Probe Request frame with the Hashed SSID IE, if the STA already knows the MAC address of the AP which is capable of hashed SSID, e.g., after receiving the Beacon frame from the AP in Step 700 in FIG. 7 or after the user manually types in the MAC address of the AP, then the STA may use the AP's MAC address as the RA in the Probe Request frame (effectively making it a unicast Probe Request) and remove the legacy SSID IE entirely. Such an example is shown in Step 704 in FIG. 7.

A legacy AP will ignore this Probe Request frame as the RA field does not match (i.e., the RA is not the MAC address of the legacy AP nor the broadcast MAC address) for it.

If the STA does not know the MAC address of the AP capable of hashed SSID (e.g., only the SSID associated with the AP is provided to an user after the user purchases the temporary usage to a fee-bearing WLAN), then the STA may also include a legacy SSID IE with a Wildcard SSID, which appears the same as a null SSID, in the Probe Request frame. Such an example is shown in Step 800 in FIG. 8. The legacy SSID IE is included here to avoid otherwise possible erroneous behavior of an implementation of a legacy AP if the legacy AP sees a Probe Request frame without an SSID IE. But, the Probe Request frame, appearing as a Wildcard Probe Request to legacy APs, may cause the legacy APs nearby to respond, as shown in Step 802 in FIG. 8. However, at least the legacy APs do not misbehave from a protocol standpoint.

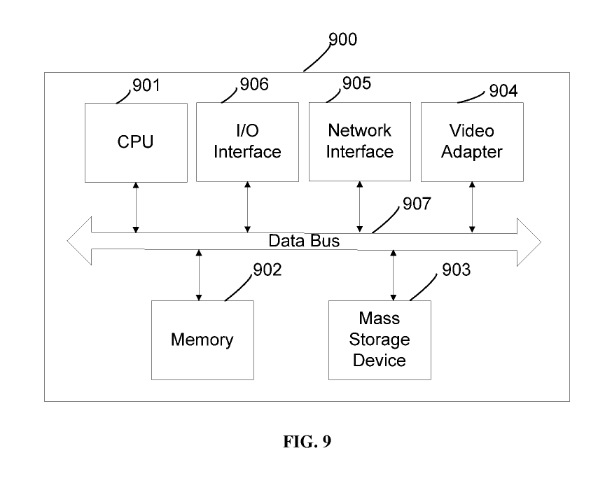

FIG. 9 is a block diagram of a processing system 900 according to an embodiment of the present disclosure. The processing system 900 may be used for implementing the devices (e.g., STA or AP) and methods disclosed herein. Specific devices may utilize all of the components shown, or only a subset of the components and levels of integration may vary from device to device. Furthermore, a device may contain multiple instances of a component, such as multiple processing units, processors, memories, transmitters, receivers, etc. The processing system 900 may be equipped with one or more input/output devices, such as a speaker, microphone, mouse, touch screen, keypad, keyboard, printer and display. The processing system 900 may include a central processing unit (CPU) 901, memory 902, a mass storage device 903, a video adapter 904 and an I/O interface 906 connected to a bus 907.

The bus 907 may be one or more of any type of several bus architectures including a memory bus or memory controller, a peripheral bus, video bus, or the like. The CPU 901 may include any type of electronic data processor. The memory 902 may include any type of system memory such as static random access memory (SRAM), dynamic random access memory (DRAM), synchronous DRAM (SDRAM), read-only memory (ROM) and a combination thereof. In an embodiment, the memory 902 may include a ROM for use at boot-up, and a DRAM for program and data storage for use while executing programs.

The mass storage device 903 may include any type of storage device configured to store data, programs, and other information and to make the data, programs, and other information accessible via the bus 907. The mass storage device 903 may include, for example, one or more of a solid state drive, hard disk drive, and an optical disk drive.

The video adapter 904 and the I/O interface 906 provide interfaces to couple external input and output devices to the processing system 900. As illustrated, examples of input and output devices include a display coupled to the video adapter 904 and the mouse/keyboard/printer coupled to the I/O interface 906. Other devices may be coupled to the processing system 900 and additional or fewer interface cards may be utilized. For example, a serial interface such as Universal Serial Bus (USB) (not shown) may be used to provide an interface for a printer.

The processing system 900 also includes one or more network interfaces 905, which may include wired links, such as an Ethernet cable, and/or wireless links to access nodes or different networks. The network interface 905 allows the processing system 900 to communicate with remote units via the networks. For example, the network interface 905 may provide wireless communications via one or more transmitters/transmit antennas and one or more receivers/receive antennas. In an embodiment, the processing system 900 is coupled to a local-area network or a wide-area network for data processing and communications with remote devices, such as other processing units, the Internet and remote storage facilities.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for secure communications between an access point and a station in a wireless network that is performed by the station, comprising:
receiving a first message from the access point in the wireless network, wherein the first message includes a first hashed service set identifier (SSID) generated by the access point by performing a first hash function on an SSID associated with the access point;
generating a second hashed SSID by performing the first hash function on an SSID known by the station;
determining whether the second hashed SSID matches the first hashed SSID; and
sending a second message to the access point when the second hashed SSID matches the first hashed SSID.

2. The method according to claim 1, wherein the generating the second hashed SSID comprises:
obtaining a first item from the first message; and
modifying the SSID known by the station with the first item to obtain a first modified SSID known by the station to be used as an input of the first hash function.

3. The method according to claim 2, wherein the generating the second hashed SSID further comprises:
generating a first hash output by using the first modified SSID known by the station; and
truncating the first hash output by using a first truncation function to obtain the second hashed SSID.

4. The method according to claim 2, wherein the first item comprises one or more of a timestamp, a value associated with a frame type of a frame that carries the first message, a nonce, a sequence number and a medium access control (MAC) address.

5. The method according to claim 3, wherein the first message is a beacon frame and the second message is a probe request frame.

6. The method according to claim 5, wherein after receiving the first message the method further comprises:
generating a second item and modifying the SSID known by the station with the second item to obtain a second modified SSID known by the station;
generating a second hash output by using the second modified SSID known by the station as an input of a second hash function;
truncating the second hash output by using a second truncation function to obtain a third hashed SSID; and
generating the second message including the third hashed SSID and the second item.

7. The method according to claim 6, wherein the first hash function and the second hash function comprise a same cryptographic hash function.

8. The method according to claim 7, wherein the first truncation function is the same as the second truncation function.

9. The method according to claim 6, wherein the second item comprises one or more of a value associated with a frame type of the probe request frame, a nonce, a sequence number and a medium access control (MAC) address.

10. The method according to claim 6, wherein:
the beacon frame comprises a first hashed SSID IE that includes the first hashed SSID, and
the probe request frame comprises a second hashed SSID IE that includes the third hashed SSID.

11. The method according to claim 3, wherein the first message is a probe response frame and the second message is an authentication request frame.

12. The method according to claim 11, wherein before receiving the probe response frame, the method further comprises:
generating a second item and modifying the SSID known by the station with the second item to obtain a second modified SSID known by the station;
generating a second hash output by using the second modified SSID known by the station as an input of a second hash function;
truncating the second hash output by using a second truncation function to obtain a third hashed SSID;
generating a probe request frame including the third hashed SSID and the second item; and
transmitting the probe request frame.

13. A station in a wireless network, comprising:
a receiver configured to receive a first message from an access point in the wireless network, wherein the first message includes a first hashed service set identifier (SSID) generated by the access point by performing a first hash function on an SSID associated with the access point;
a processor coupled to the receiver and configured to:
generate a second hashed SSID by performing the first hash function on an SSID known by the station; and
determine whether the second hashed SSID matches the first hashed SSID; and
a transmitter coupled to the processor and configured to send a second message to the access point when the second hashed SSID matches the first hashed SSID.

14. The station according to claim 13, wherein the processor is configured to:
obtain a first item from the first message; and
modify the SSID known by the station with the first item to obtain a first modified SSID known by the station to be used as an input of the first hash function.

15. The station according to claim 14, wherein the processor is further configured to:
generate a first hash output by using the first modified SSID known by the station; and
truncate the first hash output by using a first truncation function to obtain the second hashed SSID.

16. The station according to claim 14, wherein the first item comprises one or more of a timestamp, a value associated with a frame type of a frame that carries the first message, a nonce, a sequence number and a medium access control (MAC) address.

17. The station according to claim 15, wherein the first message is a beacon frame and the second message is a probe request frame.

18. The station according to claim 17, wherein the processor is configured to:
generate a second item and modify the SSID known by the station with the second item to obtain a second modified SSID known by the station;
generate a second hash output by using the second modified SSID known by the station as an input of a second hash function;
truncating the second hash output by using a second truncation function to obtain a third hashed SSID; and
generate the second message that includes the third hashed SSID and the second item.

19. The station according to claim 18, wherein the first hash function and the second hash function comprise a same cryptographic hash function.

20. The station according to claim 19, wherein the first truncation function is the same as the second truncation function.

21. The station according to claim 18, wherein the second item comprises one or more of a value associated with a frame type of the probe request frame, a nonce, a sequence number and a medium access control (MAC) address.

22. The station according to claim 18, wherein:
the beacon frame comprises a first hashed SSID IE that includes the first hashed SSID, and
the probe request frame comprises a second hashed SSID IE that includes the third hashed SSID.

23. The station according to claim 15, wherein the first message is a probe response frame and the second message is an authentication request frame.

24. The station according to claim 23, wherein the processor is further configured to:
generate a second item and modify the SSID known by the station with the second item to obtain a second modified SSID known by the station;
generate a second hash output by using the second modified SSID known by the station as an input of a second hash function;
truncate the second hash output by using a second truncation function to obtain a third hashed SSID; and
generate a probe request frame including the third hashed SSID and the second item,
wherein the transmitter is configured to send the probe request frame to the access point before the receiver receives the probe response frame.

25. A method for secure communications between an access point and a station in a wireless network that is performed by the access point, comprising:
receiving a first message from the station in the wireless network, wherein the first message includes a first hashed service set identifier (SSID) generated by the station by performing a first hash function on an SSID known by the station;
generating a second hashed SSID by performing the first hash function on an SSID associated with the access point;
determining whether the second hashed SSID matches the first hashed SSID; and
sending a second message to the station when the second hashed SSID matches the first hashed SSID.

26. The method according to claim 25, wherein the generating the second hashed SSID comprises:
obtaining a first item from the first message; and
modifying the SSID associated with the access point with the first item to obtain a first modified SSID associated with the access point to be used as an input of the first hash function.

27. The method according to claim 26, wherein the generating the second hashed SSID further comprises:
generating a first hash output by using the first modified SSID associated with the access point; and
truncating the first hash output by using a first truncation function to obtain the second hashed SSID.

28. The method according to claim 26, wherein the first item comprises one or more of a timestamp, a value associated with a frame type of a frame that carries the first message, a nonce, a sequence number and a medium access control (MAC) address.

29. The method according to claim 27, wherein the first message is a probe request frame and the second message is a probe response frame.

30. The method according to claim 29, wherein after receiving the first message the method further comprising:
generating a second item and modifying the SSID associated with the access point with the second item to obtain a second modified SSID associated with the access point;
generating a second hash output by using the second modified SSID associated with the access point as an input of a second hash function;
truncating the second hash output by using a second truncation function to obtain a third hashed SSID; and
generating the second message that includes the third hashed SSID and the second item.

31. The method according to claim 30, wherein the first hash function and the second hash function comprise a same cryptographic hash function.

32. The method according to claim 31, wherein the first truncation function is the same as the second truncation function.

33. The method according to claim 30, wherein the second item comprises one or more of a value associated with a frame type of the probe response frame, a nonce, a sequence number and a medium access control (MAC) address.

34. The method according to claim 30, wherein:
the probe request frame comprises a first hashed SSID IE that includes the first hashed SSID, and
the probe response frame comprises a second hashed SSID IE that includes the third hashed SSID.

35. The method according to claim 29, wherein before receiving the probe request frame from the station, the method further comprises:
generating a second item and modifying the SSID associated with the access point with the second item to obtain a second modified SSID associated with the access point;
generating a second hash output by using the second modified SSID associated with the access point as an input of a second hash function;
truncating the second hash output by using a second truncation function to obtain a third hashed SSID;
generating a beacon frame that includes the third SSID and the second item; and
sending the beacon frame to the station.

36. The method according to claim 27, wherein the first message is an association request frame and the second message is an association response frame.

37. An access point in a wireless network, comprising:
a receiver configured to receive a first message from a station in the wireless network, wherein the first message includes a first hashed service set identifier (SSID) generated by the station by performing a first hash function on an SSID known by the station;
a processor coupled to the receiver and configured to:
generate a second hashed SSID by performing the first hash function on an SSID associated with the access point; and
determine whether the second hashed SSID matches the first hashed SSID; and
a transmitter coupled to the processor and configured to send a second message to the station when the second hashed SSID matches the first hashed SSID.

38. The access point according to claim 37, wherein the processor is configured to:
obtain a first item from the first message; and
modify the SSID associated with the access point with the first item to obtain a first modified SSID associated with the access point to be used as an input of the first hash function.

39. The access point according to claim 38, wherein the processor is further configured to:
generate a first hash output by using the first modified SSID associated with the access point; and
truncating the first hash output by using a first truncation function to obtain the second hashed SSID.

40. The access point according to claim 38, wherein the first item comprises one or more of a timestamp, a value associated with a frame type of a frame that carries the first message, a nonce, a sequence number and a medium access control (MAC) address.

41. The access point according to claim 39, wherein the first message is a probe request frame and the second message is a probe response frame.

42. The access point according to claim 41, wherein the processor is configured to:
generate a second item and modify the SSID associated with the access point with the second item to obtain a second modified SSID associated with the access point;
generate a second hash output by using the second modified SSID associated with the access point as an input of a second hash function;
truncating the second hash output by using a second truncation function to obtain a third hashed SSID; and
generating the second message that includes the third hashed SSID and the second item.

43. The access point according to claim 42, wherein the first hash function and the second hash function comprise a same cryptographic hash function.

44. The access point according to claim 43, wherein the first truncation function is the same as the second truncation function.

45. The access point according to claim 42, wherein the second item comprises one or more of a value associated with a frame type of the probe response message, a nonce, a sequence number and a medium access control (MAC) address.

46. The access point according to claim 42, wherein:
the probe request frame comprises an SSID information element (IE) and a first hashed SSID IE, the SSID IE is set to wildcard SSID and the first hashed SSID IE includes the first hashed SSID, and
the probe response frame comprises a second hashed SSID IE that includes the third hashed SSID.

47. The access point according to claim 41, wherein the processor is configured to:
generate a second item and modifying the SSID associated with the access point with the second item to obtain a second modified SSID associated with the access point;
generate a second hash output by using the second modified SSID associated with the access point as an input of a second hash function;
truncate the second hash output by using a second truncation function to obtain a third hashed SSID; and
generate a beacon frame that includes the third SSID and the second item,
wherein the transmitter is configured to send the beacon frame to the station.

48. The access point according to claim 39, wherein the first message is an association request frame and the second message is an association response frame.
